(19) United States
(12) Patent Application Publication
(10) Pub. No.: US 2015/0213832 A1
(43) Pub. Date: Jul. 30, 2015

(54) SPINDLE MOTOR AND HARD DISK DRIVE INCLUDING THE SAME

(71) Applicant: SAMSUNG ELECTRO-MECHANICS CO., LTD., Suwon-Si (KR)

(72) Inventors: Dong Jin PARK, Suwon-Si (KR); Je Hyun BANG, Suwon-Si (KR)

(73) Assignee: SAMSUNG ELECTRO-MECHANICS CO., LTD., Suwon-Si (KR)

(21) Appl. No.: 14/597,219

(22) Filed: Jan. 15, 2015

(30) Foreign Application Priority Data
Jan. 28, 2014 (KR) 10-2014-0010139

(51) Int. Cl. G11B 19/20; F16C 32/06

(52) U.S. Cl. CPC G11B 19/2036; F16C 32/0692

(57) ABSTRACT

There is provided a spindle motor including: a lower thrust member fixed to a base member; a shaft having a lower end portion fixed to the lower thrust member; and a rotating member rotating around the shaft and having a circulating hole formed therein in order to circulate a lubricating fluid, wherein a thrust dynamic groove is formed in at least one of facing surfaces of the rotating member and the lower thrust member, and an air bubble collecting groove having a ring shape is formed in at least one of the facing surfaces of the rotating member and the lower thrust member so as to be overlapped with the circulating hole.

### CROSS-REFERENCE TO RELATED APPLICATION

This application claims the priority and benefit of Korean Patent Application No. 10-2014-0010139 filed on Jan. 28, 2014, with the Korean Intellectual Property Office, the disclosure of which is incorporated herein by reference.

### BACKGROUND

The present disclosure relates to a spindle motor and a hard disk drive including the same.

A small-sized spindle motor used in a hard disk drive (HDD) generally includes a hydrodynamic bearing assembly, and a bearing clearance filled with a lubricating fluid is formed in the hydrodynamic bearing assembly.

In addition, fluid dynamic pressure is formed in the lubricating fluid filled in the bearing clearance, while the lubricating fluid is being pumped by a thrust dynamic groove, thereby supporting a rotating member. Therefore, the rotating member may be more stably rotated.

That is, a thrust dynamic groove having a spiral pattern and a radial dynamic groove having a herringbone pattern are generally provided in such a hydrodynamic bearing assembly, and fluid dynamic pressure is generated in an axial direction and a radial direction through the thrust dynamic groove and the radial dynamic groove to promote stability in rotation of the rotating member.

However, pressure lower than atmospheric pressure, that is, negative pressure, may be generated in the bearing clearance by the pumping of the lubricating fluid at the time of rotation of the rotating member.

In this case, air components contained in the lubricating fluid may be leaked, such that air bubbles may be formed. When the air bubbles are introduced into the dynamic groove pumping the lubricating fluid, deterioration of rotational characteristics such as the generation of insufficient fluid dynamic pressure, the generation of vibrations, and the like, may be caused.

In order to prevent such a problem, the hydrodynamic bearing assembly includes a circulating hole that may decrease the generation of negative pressure, and allow air bubbles to be discharged externally by a circulated lubricating fluid.

However, micro air bubbles may not be discharged externally, but may be circulated together with the lubricating fluid in the bearing clearance to deteriorate rotational characteristics.

In other words, the development of a structure capable of preventing micro air bubbles from being circulated in the bearing clearance has been urgently demanded.

### RELATED ART DOCUMENT

(Patent Document 1) Japanese Patent Laid-Open Publication No. 2005-003172

### SUMMARY

An aspect of the present disclosure may provide a spindle motor capable of easily discharging air bubbles, and a hard disk drive including the same.

According to an aspect of the present disclosure, a spindle motor may include: a lower thrust member fixed to a base member; a shaft having a lower end portion fixed to the lower thrust member; and a rotating member rotating around the shaft and having a circulating hole formed therein in order to circulate a lubricating fluid, wherein a thrust dynamic groove is formed in at least one of facing surfaces of the rotating member and the lower thrust member, and an air bubble collecting groove having a ring shape is formed in at least one of the facing surfaces of the rotating member and the lower thrust member so as to be overlapped with the circulating hole.

The air bubble collecting groove may separate the thrust dynamic groove into two portions.

The thrust dynamic groove may be separated into an inner dynamic groove disposed in an inner portion of the air bubble collecting groove and an outer dynamic groove disposed in an outer portion of the air bubble collecting groove.

A clearance formed by the rotating member and the lower thrust member in a portion in which the inner dynamic groove is formed may be narrower than a clearance formed by the rotating member and the lower thrust member in a portion in which the outer dynamic groove is formed.

The circulating hole may be formed so as to have a diameter smaller than a width of the air bubble collecting groove, such that the circulating hole is disposed in the air bubble collecting groove.

The circulating hole may be formed so as to have a diameter larger than a width of the air bubble collecting groove, such that a portion of the circulating hole protrudes outwardly of the air bubble collecting groove.

A center of the circulating hole may be disposed so as to be offset from a central line passing through a central portion of the air bubble collecting groove and having a ring shape.

According to another aspect of the present disclosure, a spindle motor may include: a sleeve fixed to a base member and having a circulating hole formed therein in order to circulate a lubricating fluid; a shaft rotatably inserted into a shaft hole of the sleeve; and a rotor hub fixed to an upper end portion of the shaft to be thereby rotated together with the shaft, wherein a thrust dynamic groove is formed in at least one of facing surfaces of the sleeve and the rotor hub, and an air bubble collecting groove having a ring shape is formed in at least one of the facing surfaces of the sleeve and the rotor hub so as to be overlapped with the circulating hole.

According to another aspect of the present disclosure, a hard disk drive may include: the spindle motor as described above; a head transfer part transferring a head reading data from and writing data to the recording disk mounted on the spindle motor to the recording disk; and an upper case coupled to the base member provided in the spindle motor so as to form an internal space accommodating the spindle motor and the head transfer part therein.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view showing a spindle motor according to an exemplary embodiment of the present disclosure;

FIG. 2 is a bottom view of a rotating member of the spindle motor according to an exemplary embodiment of the present disclosure;

FIG. 3 is a view for describing an operation of the spindle motor according to an exemplary embodiment of the present disclosure;

FIG. 4 is a view showing a modified example of a state in which a circulating hole and an air bubble collecting groove are disposed;

FIG. 5 is a view showing another modified example of a state in which a circulating hole and an air bubble collecting groove are disposed;

FIG. 6 is a schematic cross-sectional view showing a spindle motor according to another exemplary embodiment of the present disclosure;

FIG. 7 is a plan view of a sleeve of the spindle motor according to another exemplary embodiment of the present disclosure; and

FIG. 8 is a schematic cross-sectional view showing a hard disk drive according to an exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

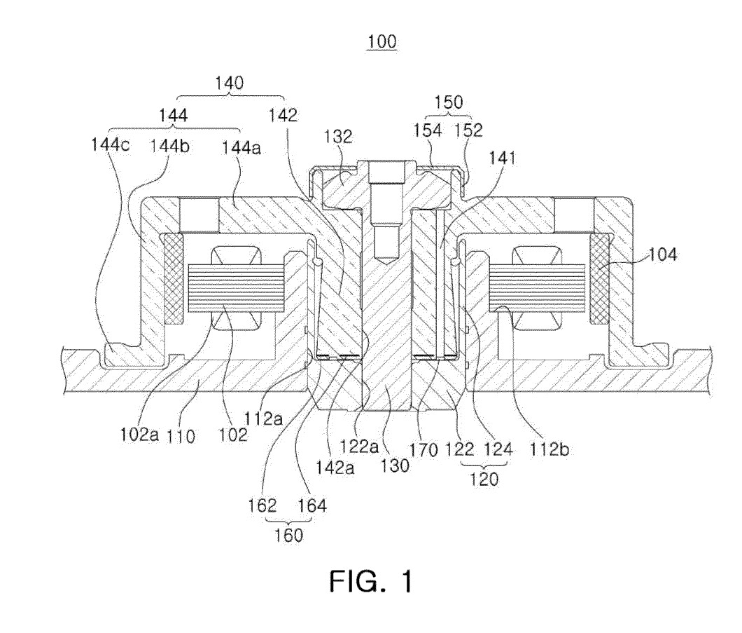

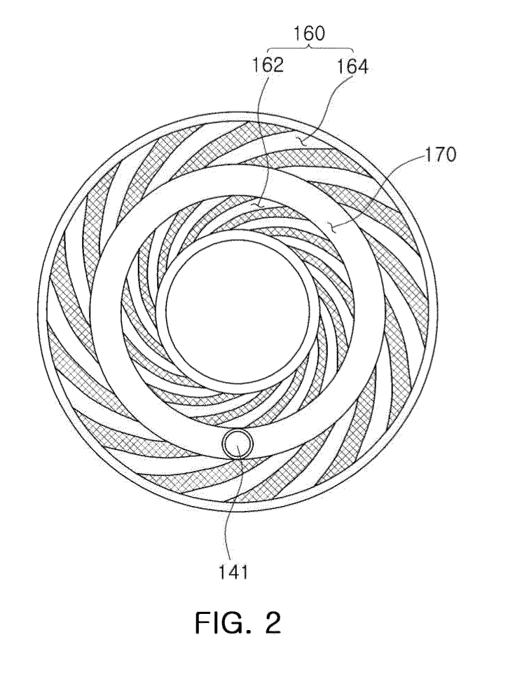

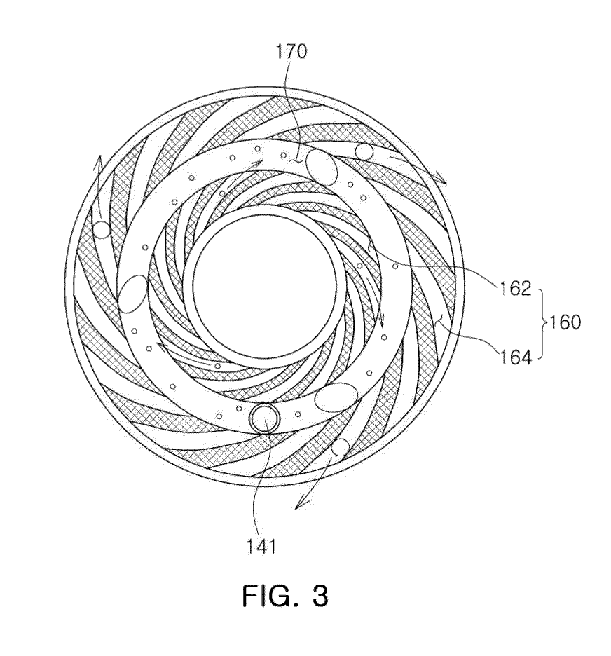

FIG. 1 is a schematic cross-sectional view showing a spindle motor according to an exemplary embodiment of the present disclosure; FIG. 2 is a bottom view of a rotating member of the spindle motor according to an exemplary embodiment of the present disclosure; and FIG. 3 is a view for describing an operation of the spindle motor according to an exemplary embodiment of the present disclosure.

Referring to FIGS. 1 through 3, a spindle motor 100 according to an exemplary embodiment of the present disclosure may include a base member 110, a lower thrust member 120, a shaft 130, a rotating member 140, and a cap member 150 by way of example.

Meanwhile, the spindle motor 100 according to an exemplary embodiment of the present disclosure may be, for example, a motor used in an information recording and reproducing device such as a hard disk drive to be described below, or the like.

The base member 110 may include an installation part 112 on which a stator core 102 is installed. The installation part 112 may be provided with an installation hole 112a into which the above-mentioned lower thrust member 120 is inserted and be extended in an upward axial direction.

Meanwhile, the installation part 112 may have a support surface 112b formed on an outer peripheral surface thereof, wherein the support surface 112b supports the stator core 102. As an example, the stator core 102 may be fixed to the installation part 112 in a state in which it is seated on the support surface 112b of the installation part 112.

Although the case in which an inner diameter part of the stator core 102 is seated and installed on the installation part 112 of the base member 110 has been described by way of example in the present exemplary embodiment, the present disclosure is not limited thereto. That is, the stator core 102 may also be installed on a separate installation member or the lower thrust member 120 of which a shape is changed in order to install the stator core 102.

The lower thrust member 120 may be inserted into the installation hole 112a of the installation part 112, and may have an outer peripheral surface bonded to an inner peripheral surface of the installation part 112.

Here, the lower thrust member 120 may be fixed to the installation part 122 by at least one of an adhering method, a press-fitting method, and a welding method.

Meanwhile, the lower thrust member 120 may include a disk part 122 having a disk shape and provided with a mounting hole 122a into which a lower end portion of the shaft 130 is inserted and a sealing wall part 124 extended from an edge of the disk part 122 in the upward axial direction.

In addition, the lower thrust member 120 may form, together with the rotating member 140, a bearing clearance in which a lubricating fluid is filled. Further, the sealing wall part 124 may form, together with the rotating member 140, a sealing part at which an interface (that is, a liquid-vapor interface) between the lubricating fluid and air is formed.

The shaft 130 may have the lower end portion fixed to the lower thrust member 120 and include a flange part 132 formed at an upper end portion thereof.

As an example, the lower end portion of the shaft 130 may be inserted into the mounting hole 122a of the lower thrust member 120 to thereby be fixed to the lower thrust member 120. That is, the spindle motor 100 according to an exemplary embodiment of the present disclosure may have a fixed shaft structure in which the shaft 130 is fixed.

Meanwhile, the shaft 130 may form, together with the rotating member 140, a bearing clearance in which a lubricating fluid is filled. Further, the flange part 132 of the shaft 130 may form, together with the rotating member 140, a sealing part at which a liquid-vapor interface is formed.

The rotating member 140 may be rotated around the shaft 130, and have a circulating hole 141 formed therein in order to circulate the lubricating fluid. A detailed description thereof will be provided below.

Meanwhile, the rotating member 140 may include a sleeve 142 forming, together with the lower thrust member 120 and the shaft 130, the bearing clearance, and a rotor hub 144 extended from the sleeve 142.

Here, terms with respect to directions will be defined. As viewed in FIG. 1, an axial direction refers to a vertical direction, that is, a direction from the lower end portion of the shaft 130 toward the upper end portion thereof or a direction from the upper end portion of the shaft 130 toward the lower end portion thereof, and a radial direction refers to a horizontal direction, that is, a direction from the shaft 130 toward an outer peripheral surface of the rotor hub 144 or from the outer peripheral surface of the rotor hub 144 toward shaft 130.

In addition, a circumferential direction refers to a rotation direction along an outer peripheral direction of the shaft 130.

The sleeve 142 may be disposed between the flange part 132 of the shaft 130 and the disk part 122 of the lower thrust member 120, and may form, together with the shaft 130 and the lower thrust member 120, the bearing clearance. Meanwhile, the sleeve 142 may have a shaft hole 142a formed therein, wherein the shaft hole 142a has the shaft 130 penetrating therethrough.

In addition, upper and lower radial dynamic grooves (not shown) may be formed in at least one of an inner peripheral surface of the sleeve 142 and the outer peripheral surface of the shaft 130. The upper and lower radial dynamic grooves may be disposed so as to be spaced apart from each other by a predetermined interval in the axial direction, and may generate fluid dynamic pressure in the radial direction at the time of rotation of the sleeve 142. Therefore, the rotating member 140 may be more stably rotated.

Meanwhile, a thrust dynamic groove 160 may be formed in at least one of facing surfaces of the rotating member 140 and the lower thrust member 120. In other words, the thrust dynamic groove 160 may be formed in at least one of a lower surface of the sleeve 142 and an upper surface of the disk part 122 of the lower thrust member 120.

The thrust dynamic groove 160 may generate fluid dynamic pressure in the axial direction at the time of the rotation of the sleeve 142. Therefore, the rotating member 140 may be rotated in a state in which it is floated from the lower thrust member 120 by a predetermined height.

In addition, an air bubble collecting groove 170 having a ring shape maybe formed in at least one of the facing surfaces of the rotating member 140 and the lower thrust member 120 so as to be overlapped with the circulating hole 141. That is, the air bubble collecting groove 170 separating the thrust dynamic groove 160 into two portions may be formed in at least one of the lower surface of the sleeve 142 and the upper surface of the disk part 122 of the lower thrust member 120 in which the thrust dynamic groove 160 is formed.

In addition, the thrust dynamic groove 160 may include an inner dynamic groove 162 disposed in an inner portion of the air bubble collecting groove 170 in the radial direction and an outer dynamic groove 164 disposed in an outer portion of the air bubble collecting groove 170 in the radial direction.

Meanwhile, a bearing clearance in a portion in which the inner dynamic groove 162 is formed may be narrower than a bearing clearance in a portion in which the outer dynamic groove 164 is formed. Therefore, grown air bubbles may be more smoothly discharged externally.

In addition, one side of the circulating hole 141 may be disposed in the air bubble collecting groove 170. In other words, the circulating hole 141 may be formed so as to have a diameter smaller than a width of the air bubble collecting groove 170, such that one side of the circulating hole 141 may be disposed in the air bubble collecting groove 170.

Meanwhile, as shown in FIG. 3, the inner dynamic groove 162 may serve to move micro air bubbles to the air bubble collecting groove 170, and the air bubble collecting groove 170 may serve to grow the collected micro air bubbles so as to have a larger size. Further, the outer dynamic groove 164 may serve to move the grown air bubbles to an outer portion of the outer dynamic groove 164 in the radial direction by surface tension.

As described above, the micro air bubbles may be collected in the air bubble collecting groove 170, be grown so as to have the larger size, and be then discharged externally through the outer dynamic groove 164, whereby the air bubbles may be more smoothly discharged. Therefore, deterioration of rotation characteristics may be suppressed.

The rotor hub 144 may be extended from the sleeve 142. Meanwhile, although the case in which the rotor hub 144 is formed integrally with the sleeve 142 has been described by way of example in the present exemplary embodiment, the present disclosure is not limited thereto. That is, the rotor hub 144 and the sleeve 142 may be manufactured separately from each other and be then coupled to each other.

Meanwhile, the rotor hub 144 may include a body 144a having a disk shape, a magnet mounting part 144b extended from an edge of the body 144a in a downward axial direction, and a disk supporting part 144c extended from a distal end of the magnet mounting part 144b in the radial direction.

In addition, the magnet mounting part 144b may have a driving magnet 104 fixedly installed on an inner surface thereof. Therefore, an inner surface of the driving magnet 104 may be disposed so as to face a front end of the stator core 102.

Meanwhile, the driving magnet 104 may be a permanent magnet generating magnetic force having a predetermined strength by alternately magnetizing an N pole and an S pole thereof in the circumferential direction.

Here, a rotational driving scheme of the rotating member 140 will be briefly described. When power is supplied to a coil 102a wound around the stator core 102, driving force capable of rotating the rotating member 140 may be generated by an electromagnetic interaction between the stator core 102 having the coil 102a wound therearound and the driving magnet 104 to rotate the rotating member 140.

That is, the driving magnet 104 and the stator core 102 disposed so as to face the driving magnet 104 and having the coil 102a wound therearound may electromagnetically interact with each other to rotate the rotating member 140.

The cap member 150 may be fixed to the rotating member 140 to prevent leakage of the lubricating fluid. Meanwhile, the cap member 150 may include a bonded part 152 having an inner peripheral surface bonded to the rotating member 140 and a cover part 154 bent from the bonded part 152 in an inner diameter direction.

That is, in the case in which the bonded part 152 of the cap member 150 is bonded to the rotating member 140, the cover part 154 may be disposed above the flange part 132 of the shaft 100 to prevent the leakage of the lubricating fluid.

Meanwhile, the cap member 150 is not a necessary component of the spindle motor 100 according to an exemplary embodiment of the present disclosure. Therefore, the cap member 150 may be omitted.

As described above, the micro air bubbles may be grown through the air bubble collecting groove 170 and be then discharged externally through the outer dynamic groove 164, whereby the deterioration of the rotational characteristics due to the micro air bubbles may be prevented.

That is, the air bubble may be more smoothly discharged, whereby the deterioration of the rotational characteristics may be prevented.

Next, modified examples of a state in which a circulating hole and an air bubble collecting groove are disposed will be described with reference to the accompanying drawings.

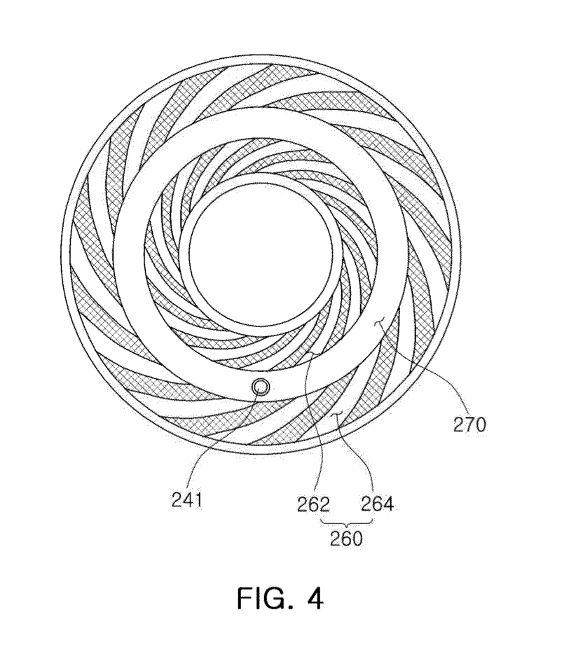

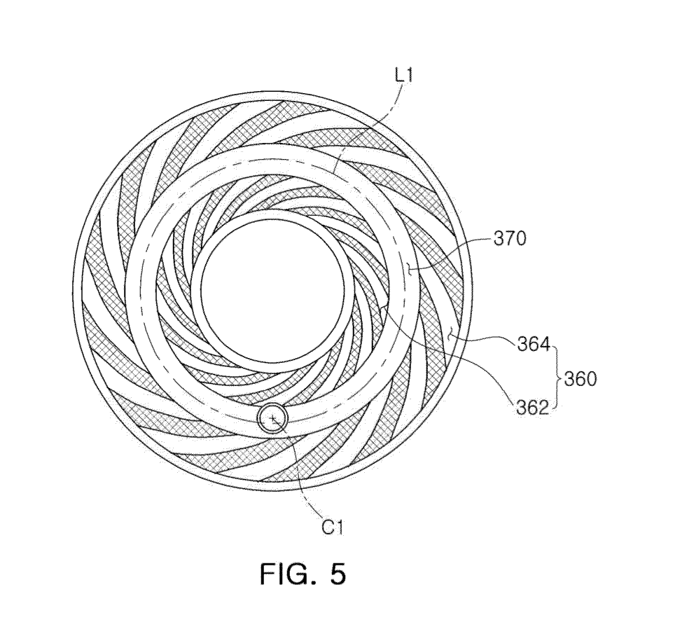

FIG. 4 is a view showing a modified example of a state in which a circulating hole and an air bubble collecting groove are disposed; and FIG. 5 is a view showing another modified example of a state in which a circulating hole and an air bubble collecting groove are disposed.

Referring to FIG. 4, a circulating hole 241 may be formed so as to have a diameter larger than a width of an air bubble collecting groove 270, such that a portion of the circulating hole 241 may protrude outwardly of the air bubble collecting groove 270.

In addition, referring to FIG. 5, the center C1 of a circulating hole 341 may be disposed so as to be offset from a central line L1 passing through a central portion of an air bubble collecting groove 370 and having a ring shape.

As described above, a diameter of the circulating hole 241 or 341 and a width of the air bubble collecting groove 270 or 370 may be variously modified.

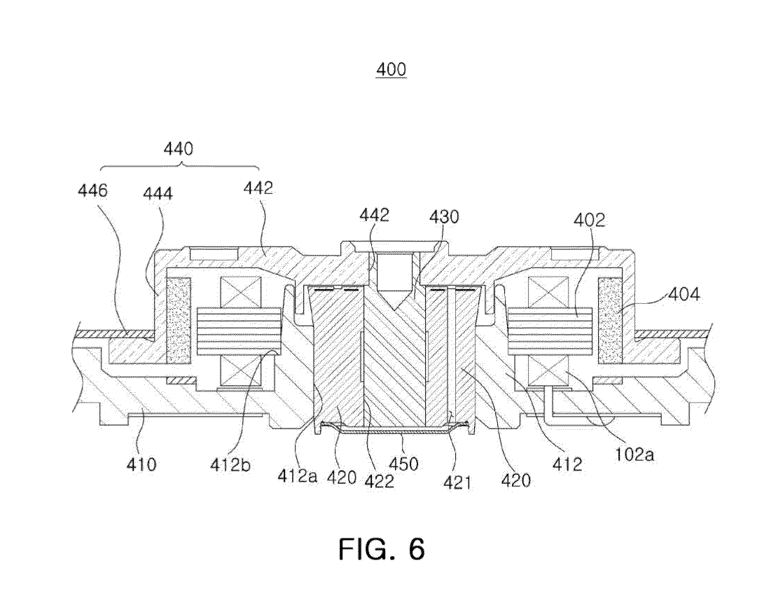

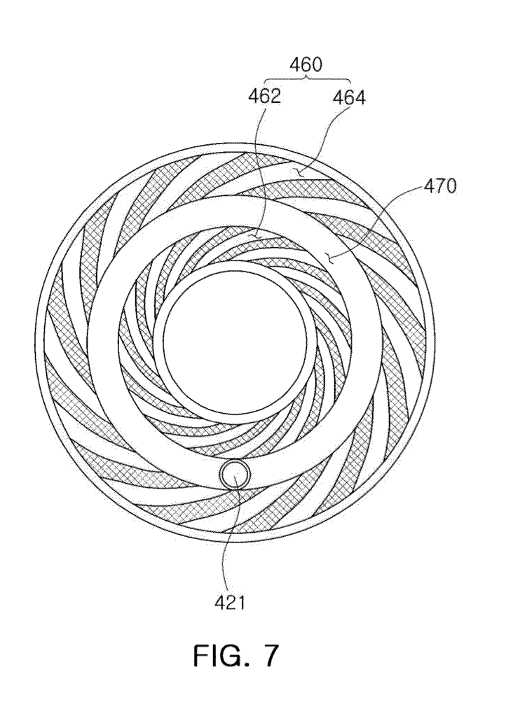

FIG. 6 is a schematic cross-sectional view showing a spindle motor according to another exemplary embodiment of the present disclosure; and FIG. 7 is a plan view of a sleeve of the spindle motor according to another exemplary embodiment of the present disclosure.

Referring to FIGS. 6 and 7, a spindle motor 400 according to another exemplary embodiment of the present disclosure may include a base member 410, a sleeve 420, a shaft 430, a rotor hub 440, and a cover member 450 by way of example.

The base member 410 may include an installation part 412 having the sleeve 420 installed therein. The installation part 412 may protrude in the upward axial direction and have a hollow cylindrical shape. In addition, the installation part 412 may have the sleeve 420 inserted thereinto.

In addition, the installation part 412 may have a stator core 402 installed on an outer peripheral surface thereof, wherein the stator core 402 has a coil 402a wound therearound. That is, the stator core 402 may be fixed to the installation part 412 by an adhesive in a state in which it is seated on a support surface 412a formed on the outer peripheral surface of the installation part 412.

The sleeve 420 may rotatably support the shaft 430. In addition, as described above, the sleeve 420 may be inserted into and fixed to the installation part 412. That is, an outer peripheral surface of the sleeve 420 may be adhered to an inner peripheral surface of the installation part 412 by an adhesive.

However, the sleeve 420 is not limited to being bonded to the installation part 412 by the adhesive, but may also be bonded to the installation part 412 by press-fitting or welding.

In addition, the sleeve 420 may have a circulating hole 421 formed therein in order to circulate the lubricating fluid. Further, the sleeve 420 may have a shaft hole 422 formed therein so that the shaft 430 may be inserted thereinto. That is, the sleeve 420 may have a hollow cylindrical shape.

Meanwhile, in the case in which the shaft 430 is inserted into the sleeve 420, an inner peripheral surface of the sleeve 420 and an outer peripheral surface of the shaft 430 may be spaced apart from each other by a predetermined interval to form a bearing clearance therebetween. This bearing clearance may be filled with the lubricating fluid.

In addition, the sleeve 420 may have the cover member 450 installed at a lower end portion thereof in order to prevent the lubricating fluid filled in the above-mentioned bearing clearance from being leaked downwardly.

Here, the bearing clearances will be briefly described. The bearing clearances may be formed by the sleeve 420 and the shaft 430, the sleeve 420 and the rotor hub 440, the cover member 450 and sleeve 420, and the cover member 450 and the shaft 430 and be filled with the lubricating fluid.

That is, the spindle motor 400 according to another exemplary embodiment of the present disclosure may have a full-fill structure in which the lubricating fluid is filled in all of the above-mentioned bearing clearances.

Meanwhile, upper and lower radial dynamic grooves (not shown) may be formed in at least one of an inner peripheral surface of the sleeve 420 and an outer peripheral surface of the shaft 430. The upper and lower radial dynamic grooves may be disposed so as to be spaced apart from each other by a predetermined interval in the axial direction, and may generate fluid dynamic pressure in the radial direction at the time of rotation of the shaft 430. Therefore, the shaft 430 maybe more stably rotated.

Meanwhile, a thrust dynamic groove 460 may be formed in at least one of facing surfaces of the sleeve 420 and the rotor hub 440. Meanwhile, the thrust dynamic groove 460 may be formed in at least one of an upper surface of the sleeve 420 and a lower surface of the rotor hub 440.

The thrust dynamic groove 460 may generate fluid dynamic pressure in the axial direction at the time of the rotation of the shaft 430. Therefore, the shaft 430 may be rotated in a state in which it is floated by a predetermined height.

In addition, an air bubble collecting groove 470 having a ring shape maybe formed in at least one of the facing surfaces of the sleeve 420 and the rotor hub 440 so as to be overlapped with the circulating hole 421. That is, the air bubble collecting groove 470 separating the thrust dynamic groove 460 into two portions may be formed in at least one of the upper surface of the sleeve 420 and the lower surface of the rotor hub 440 in which the thrust dynamic groove 460 is formed.

In addition, the thrust dynamic groove 460 may include an inner dynamic groove 462 disposed in an inner portion of the air bubble collecting groove 470 in the radial direction and an outer dynamic groove 464 disposed in an outer portion of the air bubble collecting groove 470 in the radial direction.

Meanwhile, a bearing clearance in a portion in which the inner dynamic groove 462 is formed may be narrower than a bearing clearance in a portion in which the outer dynamic groove 464 is formed. Therefore, grown air bubbles may be more smoothly discharged externally.

In addition, one side of the circulating hole 421 may be disposed in the air bubble collecting groove 470. In other words, the circulating hole 421 may be formed so as to have a diameter smaller than a width of the air bubble collecting groove 470, such that one side of the circulating hole 421 may be disposed in the air bubble collecting groove 470.

The shaft 430 may be rotatably installed in the sleeve 420. That is, the shaft 430 may be inserted into the shaft hole 422 of the sleeve 420. Further, the shaft 430 may have the rotor hub 440 fixed to an upper end portion thereof. The rotor hub 440 may be fixed to the upper end portion of the shaft 403, such that the shaft 430 and the rotor hub 440 may be rotated together with each other.

The rotor hub 440 may include a body 442 provided with a through-hole 442a into which the shaft 430 is inserted, a magnet mounting part 444 extended from an edge of the body 442 in the downward axial direction, and a disk supporting part 446 extended from a distal end of the magnet mounting part 444 in an outer diameter direction.

In addition, the magnet mounting part 444 may have a driving magnet 404 installed on an inner surface thereof, wherein the driving magnet 404 is disposed so as to face a distal end of the stator core 402 having the coil 402a wound therearound.

The cover member 450 may be fixed to the lower end portion of the sleeve 420 in order to prevent leakage of the lubricating fluid. In addition, the cover member 450 may have a circular plate shape, and may be bonded to the lower end portion of the sleeve 420 by at least one of an adhering method and a welding method.

As described above, the micro air bubbles may be grown through the air bubble collecting groove 470 and be then discharged externally through the outer dynamic groove 464, whereby the deterioration of the rotational characteristics due to the micro air bubbles may be prevented.

That is, the air bubble may be more smoothly discharged, whereby the deterioration of the rotational characteristics may be prevented.

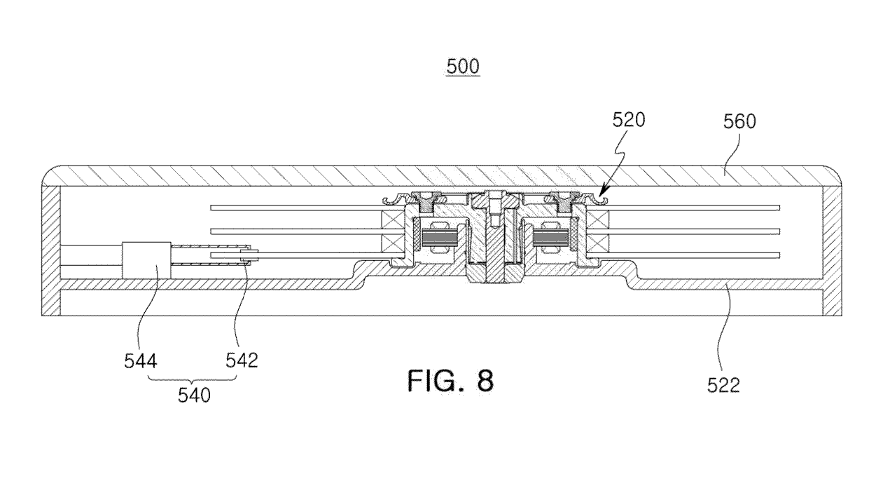

FIG. 8 is a schematic cross-sectional view showing a hard disk drive according to an exemplary embodiment of the present disclosure.

Referring to FIG. 8, a hard disk drive 500 according to an exemplary embodiment of the present disclosure may include a spindle motor 520, a head transfer part 540, and an upper case 560 by way of example.

The spindle motor 520 may be any one of the spindle motor 100 according to an exemplary embodiment of the present disclosure and the spindle motor 200 according to another exemplary embodiment of the present disclosure described above, and may have a recording disk D mounted thereon.

The head transfer part 540 may transfer a head 542 reading data from and writing data to the recording disk D mounted on the spindle motor 520 to a surface of the recording disk D of which the information is to be detected. The head 542 may be disposed on a support part 544 of the head transfer part 540.

The upper case 560 may be coupled to a base member 522 in order to form an internal space accommodating the spindle motor 520 and the head transfer part 540 therein.

The micro air bubbles may be collected through the air bubble collecting groove, be grown so as to have the large size, and be then discharged externally, whereby the air bubbles may be easily discharged.

Therefore, the deterioration of the rotation characteristics may be prevented.

While exemplary embodiments have been shown and described above, it will be apparent to those skilled in the art that modifications and variations could be made without departing from the scope of the present invention as defined by the appended claims.

What is claimed is:

1. A spindle motor comprising:
a lower thrust member fixed to a base member;
a shaft having a lower end portion fixed to the lower thrust member; and
a rotating member rotating around the shaft and having a circulating hole formed therein in order to circulate a lubricating fluid,
wherein a thrust dynamic groove is formed in at least one of facing surfaces of the rotating member and the lower thrust member, and
an air bubble collecting groove having a ring shape is formed in at least one of the facing surfaces of the rotating member and the lower thrust member so as to be overlapped with the circulating hole.

2. The spindle motor of claim 1, wherein the air bubble collecting groove separates the thrust dynamic groove into two portions.

3. The spindle motor of claim 2, wherein the thrust dynamic groove is separated into an inner dynamic groove disposed in an inner portion of the air bubble collecting groove and an outer dynamic groove disposed in an outer portion of the air bubble collecting groove.

4. The spindle motor of claim 3, wherein a clearance formed by the rotating member and the lower thrust member in a portion in which the inner dynamic groove is formed is narrower than a clearance formed by the rotating member and the lower thrust member in a portion in which the outer dynamic groove is formed.

5. The spindle motor of claim 1, wherein the circulating hole is formed so as to have a diameter smaller than a width of the air bubble collecting groove, such that the circulating hole is disposed in the air bubble collecting groove.

6. The spindle motor of claim 1, wherein the circulating hole is formed so as to have a diameter larger than a width of the air bubble collecting groove, such that a portion of the circulating hole protrudes outwardly of the air bubble collecting groove.

7. The spindle motor of claim 1, wherein a center of the circulating hole is disposed so as to be offset from a central line passing through a central portion of the air bubble collecting groove and having a ring shape.

8. A spindle motor comprising:
a sleeve fixed to a base member and having a circulating hole formed therein in order to circulate a lubricating fluid;
a shaft rotatably inserted into a shaft hole of the sleeve; and
a rotor hub fixed to an upper end portion of the shaft to be thereby rotated together with the shaft,
wherein a thrust dynamic groove is formed in at least one of facing surfaces of the sleeve and the rotor hub, and
an air bubble collecting groove having a ring shape is formed in at least one of the facing surfaces of the sleeve and the rotor hub so as to be overlapped with the circulating hole.

9. The spindle motor of claim 8, wherein the air bubble collecting groove separates the thrust dynamic groove into two portions.

10. A hard disk drive comprising:
the spindle motor of claim 1 rotating a recording disk;
a head transfer part transferring a head reading data from and writing data to the recording disk mounted on the spindle motor to the recording disk; and
an upper case coupled to the base member provided in the spindle motor so as to form an internal space accommodating the spindle motor and the head transfer part therein.
